(19) United States
(12) Patent Application Publication
(10) Pub. No.: US 2026/0274612 A1
(43) Pub. Date: Sep. 17, 2026

(54) CALL-SOURCE-DEPENDENT CONTROL OF AN ELEVATOR DISPLAY DEVICE

(71) Applicant: INVENTIO AG, Hergiswil (CH)

(72) Inventor: Jacqueline Walther, Ebikon (CH)

(21) Appl. No.: 19/473,473

(22) PCT Filed: May 22, 2024
(86) PCT No.: PCT/EP2024/064074

§ 371 Date: Oct. 7, 2025

(30) Foreign Application Priority Data
May 30, 2023 (EP) 23176009.1

(51) Int. Cl. B66B 3/00; B66B 1/34; B66B 1/46

(52) U.S. Cl. CPC B66B 3/002; B66B 1/3461; B66B 1/468; B66B 2201/103; B66B 2201/4615; B66B 2201/463; B66B 2201/4638; B66B 2201/4653

(57) ABSTRACT

An elevator system having an elevator controller and elevator display devices assigned to an elevator car on floors. The elevator controller receives an elevator call originating from an elevator operating device, as a first call source, on a call entry floor via a communication network. The elevator controller receives an elevator call originating from a mobile communication device, as a second call source, on a call entry floor via a communication interface device. The elevator controller generates a control signal for the elevator display device which is assigned to the elevator car serving the elevator call on the call entry floor. The control signal indicates whether the elevator call originates from the first or the second call source. Upon receipt of the control signal, the elevator display device communicates an indicator perceptible on the call entry floor which identifies the first or second call source.

### DESCRIPTION

The technology described herein relates in general to an elevator system in a building. Exemplary embodiments of the technology relate in particular to an elevator system with an elevator operating device and to a method for operating such an elevator system.

In a building with an elevator system, elevator operating devices are provided on the floors served by the elevator system, with which a person can enter an elevator call. Said elevator operating devices can include up/down buttons so that the person can enter the desired direction of travel on a floor. Alternatively, the elevator operating devices can be configured in such a way (e.g., have a keyboard or a touch-sensitive screen) that the person can enter a desired destination floor. When the direction of travel or the destination floor is entered, an elevator call is registered (a direction call in case of up/down buttons, and otherwise a destination call). It is also known that a person can use their appropriately configured mobile phone to enter an elevator call. In addition, elevator display devices are available on the floors, which are located, for example, above shaft doors so that they can be seen by people located in front of them on the floors. Such an elevator display device shows, for example, the position, direction of travel and/or arrival of an elevator car that serves an elevator call. Elevator systems having such elevator display devices are disclosed, for example, in U.S. Pat. No. 10,414,627 B1 and US 2018/0257909A1 .

An elevator system can provide for an elevator call to be made using both an elevator operating device and a mobile phone; it can moreover have one or more elevator cars (“elevators”), wherein several elevators can be arranged in one or more elevator groups. With such an elevator system, it can happen that, in particular when several elevator calls are made from people on a floor, the people become confused and may delay boarding because they cannot clearly see which elevator car serves which elevator call. There is therefore a need for a technology for an elevator system in which this problem is completely or at least partially eliminated.

One aspect of the technology described herein relates to an elevator system having an elevator controller communicatively connected to a communication interface device and a communication network. An elevator car can be moved, in a manner controlled by the elevator controller, between floors. The elevator system also has elevator operating devices that are communicatively connected to the communication network and arranged on the floors for entering elevator calls, and elevator display devices that are communicatively connected to the communication network and assigned to the elevator car on the floors. The elevator display devices are arranged separately from the elevator operating devices and configured to receive control signals from the elevator controller via the communication network. The elevator controller is configured to receive a first elevator call originating from an elevator operating device on a call entry floor via the communication network, wherein said elevator operating device constitutes a first call source. The elevator controller is moreover configured to receive an elevator call originating from a mobile communication device on a call entry floor via the communication interface device, wherein said mobile communication device constitutes a second call source. The elevator controller is configured to generate a control signal for the elevator display device which is assigned to the elevator car serving the elevator call on the call entry floor and to send it to said elevator display device. The control signal indicates the first or second call source. The elevator display device is configured to communicate, upon receipt of the control signal, an indicator perceptible on the call entry floor which identifies the call source specified in the control signal.

Another aspect of the technology relates to a method for operating the elevator system. The method includes receiving an elevator call by the elevator controller, determining an elevator serving the elevator call by the elevator controller, and determining an origin of the elevator call by the elevator controller. Upon receipt of the elevator call via the communication network, an elevator operating device on a call entry floor constitutes a first call source, and upon receipt of the elevator call via the communication interface device, a mobile communication device on a call entry floor constitutes a second call source. The method further includes generating a control signal for the elevator display device assigned to the elevator car serving the elevator call on the call entry floor and sending the control signal to said elevator display device. The control signal indicates whether the elevator call originates from the first or the second call source. The method further includes activating the elevator display device upon receipt of the control signal to communicate an indicator perceptible on the call entry floor that identifies the first or second call source.

With the technology described herein, an elevator system is created in which an elevator display device on a call entry floor not only perceptibly communicates (in particular visibly indicates) the elevator car serving an elevator call, but also whether the elevator car is serving an on-site call or a remote call. An indicator is used for communication. In one exemplary embodiment, the elevator display devices are arranged above shaft doors; on the call entry floor, the elevator display device displays the indicator that a person on the call entry floor can perceive. This helps the person to identify the elevator car serving their elevator call better and possibly more quickly. The additional information makes the elevator system more user-friendly overall.

There is substantially freedom of design as regards the indicator. The indicator can include a symbol, an alphanumeric character, a pictogram, a color, an acronym and/or a word. For example, the indicator can be a substantially self-explanatory symbol or pictogram; a symbol or pictogram for a radio transmission or mobile phone can indicate a remote call, or a symbol or pictogram for a keyboard can indicate a manual call entry on an elevator operating device in case of an on-site call.

The technology described herein is not limited to a specific elevator system control technology. In one exemplary embodiment, the elevator controller includes a destination call controller, wherein each elevator call indicates a destination floor. The elevator operating devices and the mobile communication device are configured to send an entered destination floor as an elevator call to the elevator controller. The generated control signal additionally indicates the destination floor, and the elevator display device is configured to perceptibly communicate the destination floor in conjunction with the indicator. In another exemplary embodiment, the elevator controller includes a direction controller, wherein the elevator operating devices and the mobile communication device are configured to send an entered direction of travel as an elevator call to the elevator controller.

In one exemplary embodiment, the communication interface device is configured to receive a radio signal in accordance with a specified standard for mobile radio communication. The mobile communication device sends and receives radio signals according to said standard. The standard is in particular an ETSI standard for mobile radio communication (e.g., GSM, 3G/UMTS, 4G/LTE, 5G), according to which commercially available mobile devices communicate.

Various aspects of the improved technology are described in greater detail below in conjunction with the drawings with reference to exemplary embodiments. In the figures, identical elements have identical reference signs. In the figures:

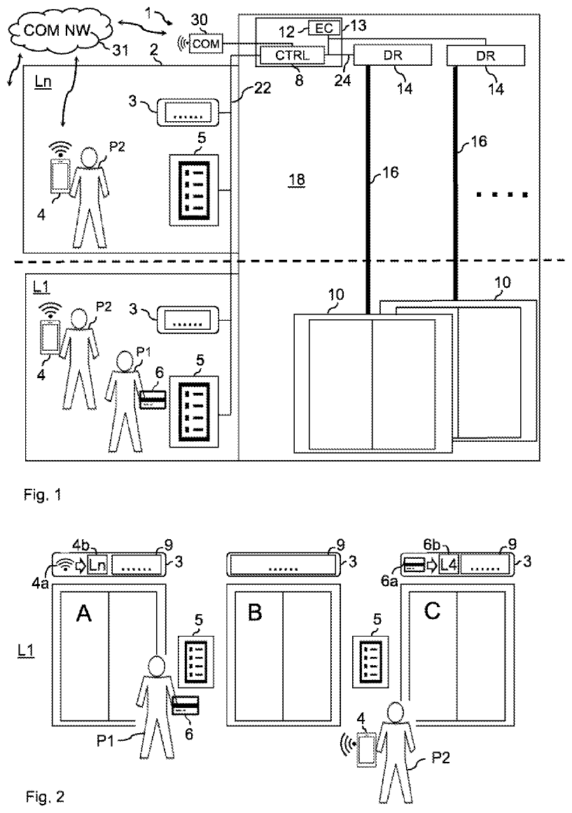

FIG. 1 shows a schematic representation of an exemplary elevator system in a building having multiple floors;

FIG. 2 shows a schematic representation of an exemplary situation in an elevator hall on a floor; and

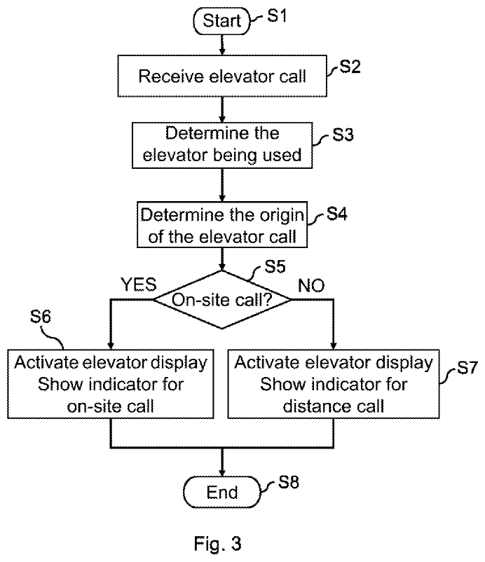

FIG. 3 shows an exemplary representation of an exemplary embodiment of a method for operating the elevator system.

FIG. 1 is a schematic representation of an exemplary elevator system 1 in a building 2 having multiple floors L1, Ln that are served by an elevator system 1. The floor L1 can be an entrance hall of the building 2, into which hall the passengers P1, P2 enter when accessing the building 2 and from which they leave the building 2 again. When a passenger P1, P2 enters the floor L1, each floor L1, Ln of the building 2 can, with the appropriate access authorization, be reached from that floor by means of the elevator system 1. The elevator system 1 shown has two elevator cars 10, which may also be referred to as “elevators” below. Moreover, for presentation purposes, only one elevator controller 13 (EC, CTRL), two drive machines 14 (DR), support means 16 (e.g., steel cables or flat belts), a communication interface device 30 (in particular for mobile radio communication) and a number of elevator display devices 3 and elevator operating devices 5 of the elevator system 1 are shown in FIG. 1, which are communicatively connected to the elevator controller 13 via a communication network 22. A person skilled in the art will recognize that the elevator system 1 can also include one or more than two elevator cars 10 (as indicated by dots in FIG. 1), wherein several elevator cars 10 can be moved in one or more shafts 18 and controlled by a group controller. Instead of the traction elevators shown in FIG. 1, the elevator system 1 can also have one or more hydraulic elevators.

In the exemplary embodiment shown in FIG. 1, an elevator operating device 5 is arranged on each floor L1, Ln, at which elevator operating device a passenger P1, P2 can enter an elevator call and thus call an elevator to the floor L1, Ln. The floor L1, Ln on which the person P1, P2 is located and is calling the elevator is also referred to as the call entry floor. For entering a call, the elevator operating device 5 can be equipped with a keyboard, a touch-sensitive screen system or a device for contactless detection of a credential 6, wherein the elevator operating device 5 can be equipped for both contact-based and contactless entry. When such a call is entered, the person P1, P2 is substantially in the immediate vicinity of the elevator operating device 5; such an elevator call is also referred to below as an “on-site call” in order to distinguish it from a remote call referred to below. In FIG. 1, the person Pl uses for example a credential 6 (shown in the form of a credit card) in conjunction with call entry.

In addition, in the elevator system 1 shown, an elevator call can be entered using a mobile electronic device 4 (hereinafter referred to as mobile device 4). When such a call is entered, the person P1, P2 is located on the call entry floor, but not in the immediate vicinity of an elevator operating device 5; such an elevator call can also be referred to as a remote call. In FIG. 1, the person P2 uses their mobile device 4 to enter a remote call.

Exemplary configurations and functionalities of the elevator operating device 5, mobile device 4 and credential 6 are given elsewhere in this description. Both the elevator operating device 5, at which the passenger Pl enters the elevator call, and the mobile device 4, with which the passenger P2 enters the elevator call, can also be referred to below as call sources.

The elevator system 1 can be equipped with an up/down controller or a destination call controller. A person skilled in the art recognizes that mixed forms of the aforementioned control technologies can also be possible. If the elevator system 1 is equipped with an up/down controller, elevator operating devices 5 will be arranged on the floors L1, Ln, at which a desired direction of travel (i.e., a direction call) can be entered. It can furthermore be provided that a mobile device 4 can be used to enter a direction call. The desired destination floor is then entered in the car 10 on an elevator operating device arranged therein (not shown in FIG. 1); such destination floor entry in the car 10 can also be referred to as a car call. If the elevator system 1 is equipped with a destination call controller, elevator operating devices 5 are arranged on the floors L1, Ln on which a desired destination floor can be entered; a destination call is then registered as an elevator call. It can moreover be provided that a mobile device 4 can be used to enter a destination call. After entering the destination floor, information about the call entry floor (boarding floor) and the destination floor is available. The call entry floor is defined, for example, by the location of the elevator operating device 5 (e.g., from a building plan) at which the destination floor is entered.

In the exemplary embodiment shown in FIG. 1, after a call has been entered, an elevator car 10 is selected to serve the elevator call. If not yet on the boarding floor, the selected elevator car 10 will be moved to the boarding floor. Depending on the control technology implemented in the elevator system 1, the selected elevator car 10 is displayed on the elevator operating device 5 or mobile device 4 (for example, in case of a destination call controller), or the corresponding elevator display device 3 is controlled to generate an audible and visible message upon arrival of the elevator car 10 on the boarding floor (for example, in case of an up/down controller).

Hereinafter, the technology disclosed herein is substantially described with reference to the elevator system 1 shown FIG. 1, which is equipped with the destination call controller as an example. In the exemplary embodiment shown, the functionality of the destination call controller is represented by a control device (CTRL) 8, which, in addition to a control unit 12, is also assigned to the elevator controller 13. In this description, the designation “destination call controller” is understood to mean the components (e.g., computers, processors, storage devices) and associated control and computer programs which execute the functions described below and/or are involved in their execution. The control device 8 is representative of these components and control and computer programs shown in FIG. 1. A person skilled in the art will recognize that one or more functions of the destination call controller can be carried out in or by one or more elevator operating devices 5. The destination call controller carries out an allocation procedure, the principle of which is described, for example, in the following publication: Koehler, Jana, et al., An AI-Based Approach to Destination Control in Elevators, AI Magazine, Vol. 23, No. 3, 2002, pp. 59-78. Upon receipt of a destination call identifying the call entry floor and the destination floor, the allocation procedure uses so-called job managers, calculates “costs” and applies one or more cost functions to determine from “offers” of elevators that could serve an elevator call the elevator that can best, i.e., most cost-effectively, serve the elevator call.

In one exemplary embodiment, the control device 8 or its functionality can be implemented completely or partially in the elevator controller 13. If the elevator system 1 includes one or more groups of elevators, the functionality of the destination call controller can be implemented completely or partially in a group controller, e.g., implemented in the control unit 12. In one exemplary embodiment, the destination call controller assigns a received elevator call (destination call) of a person P1, P2 to one of, for example, several elevator cars 10 present in the elevator system 1 and communicates the corresponding allocation information via a communication network 24 to the control unit 12, which controls the movement of the assigned elevator car 10, and via the communication network 22 to the elevator operating device 5, at which the person Pl is located when entering the call, or via the mobile radio communication network 31 to the mobile device 4, which the person P2 uses to enter the call.

FIG. 2 shows a schematic representation of an exemplary situation in an elevator hall on a floor, for example on floor L1. In this exemplary embodiment, the elevator system 1 is equipped with destination call controller technology. In this situation, three elevators A, B, C are shown, an elevator display device 3 being arranged above each of the elevators A, B, C, but without being limited to this arrangement. In the elevator hall there are persons Pl and P2, each of whom has already entered an elevator call. Person Pl has entered the elevator call (on-site call) in conjunction with their credential 6 on the elevator operating device 5, e.g., to travel to a floor L4; the destination floor can be stored, e.g., on the credential 6 or in conjunction with a user profile in the elevator controller 13 or a building management system; alternatively, the destination floor can be entered after presenting the (valid) credential 6 on the elevator operating device 5, which is then enabled for entering a call.

Person P2 has entered the elevator call (remote call) with their mobile device 4, for example to go to floor Ln. The mobile device 4 is equipped for communication via a mobile radio communication network 31 in accordance with an ETSI standard for mobile radio communication, e.g., GSM, 3G/UMTS, 4G/LTE, 5G, or a future standard; the communication interface device 30 is equipped complementarily thereto. Such communication is shown by way of example in FIG. 1: the communication interface device 30 communicates with the mobile device 4 via the mobile radio communication network 31, which is indicated by several double arrows as an example. The mobile device 4 is additionally equipped with a software application (app) for elevator operation. For example, the app can generate a graphical user interface that displays the mobile device 4 to enable interaction with the mobile device 4.

A location of the mobile device 4 can be determined using known positioning methods; for example, the mobile device 4 can transmit its position determined via GPS to the elevator controller 13; alternatively, the mobile device 4 can detect an optical code (e.g., a QR code) arranged on a carrier material on the floor and send it to the elevator controller 13. The location of the carrier material or optical code can be documented in a building plan. It is also possible that a radio device, the position of which can also be documented in a building plan, is located on the floor; the radio appliance can, for example, transmit a radio signal using WLAN or Bluetooth technology. The mobile device 4 detects a password contained in the radio signal and sends it to the elevator controller 13. The elevator controller 13 determines the call entry floor using the received optical code or password, for example in conjunction with the building plan.

In the exemplary embodiment shown, after receiving the elevator calls from persons P1, P2, the elevator controller 13 has selected (assigned) elevators A and C, for example, to serve the elevator calls. The elevator controller 13 generates control signals accordingly and thereby controls the elevator display devices 3 of the assigned elevators A and C.

According to the technology described herein, the elevator display devices 3 are controlled such that they not only display or announce that the respective elevator A, C has been selected or has arrived on, or is on its way to, the floor, but also display whether elevator A, C is serving a remote call or an on-site call. The origin of an elevator call is thus displayed, wherein the information regarding the call source is contained in the control signal that the elevator controller 13 sends to the corresponding elevator display device 3.

In FIG. 2, the different control of the elevator display devices 3 with reference to the different call sources or call types (remote call and on-site call) is exemplified by different indicators that the elevator display devices 3 display. The elevator display device 3 above elevator A displays a radio symbol 4a as an indicator. This indicates that elevator A serves a remote call originating from the mobile phone 4 (call source) on said floor. In addition, the floor Ln to which elevator A travels can be displayed in a display region 4b. In the exemplary embodiment of FIG. 2, a horizontal arrow is moreover shown. The display shown indicates that elevator A is servicing a remote call and is traveling to floor Ln.

The elevator display device 3 above elevator C displays a card symbol 6a as an indicator. This indicates that elevator C is serving an on-site call that was entered at an elevator operating device 5 (call source). Moreover, in this exemplary embodiment, a horizontal arrow and the destination floor L4 can also be displayed in a display region 6b. This indicates that elevator C is serving an on-site call entered via elevator operating device 5 and is traveling to floor L4.

In FIG. 2, it is also indicated that further information can be displayed in a display region 9 in order to inform the persons P1, P2 on the floor L1. For example, the position of the elevator car 10, its direction of travel and/or load (e.g., number of persons or degree of load (low or high)), and/or an operating mode of the elevator system 1 (e.g., energy saving mode, standby, out of service, maintenance, cleaning) can be displayed.

In another exemplary embodiment, the elevator system 1 is equipped with an up/down controller. In such case, the persons P1, P2 on the floor L1 simply enter the desired directions of travel as an on-site call or remote call on the elevator operating device 5 or mobile device 4. The standard or the call entry floor is determined as described above. Each person then enters the desired destination floor P1, P2 in the respective elevator car 10. In this exemplary embodiment, the elevator display devices 3 each also display the indicator (radio symbol 4a or card symbol 6a), but without a destination floor.

The configuration (e.g., as a display device with an LED matrix display or an LED/LCD screen) and control of the elevator display devices 3 are known to a person skilled in the art. A person skilled in the art will also recognize that the indicators (4a, 6b), display regions 4b, 6b, 9, their designs (including sizes and possibly color and animated designs) and arrangements shown in FIG. 2 are exemplary and not limited thereto. In another exemplary embodiment, the indicator can include, for example, an alphanumeric character, a pictogram, a color, an acronym, and/or a word. A call confirmation received by the person P1, P2 at the elevator operating device 5 or at the mobile device 4 can, for example, be colored, and the displayed indicator can then be colored in the same way.

With the understanding of the above-described basic system components of the elevator system 1 and their functionalities, a description of an exemplary method for operating the elevator system 1 shown in FIG. 1 is given below with reference to FIG. 3. FIG. 3 shows an example of a flow chart of the method; it begins at step S1 and ends at step S8. A person skilled in the art will recognize that the division into these steps is by way of example, and that one or more of these steps can be divided into one or more sub-steps, or that a plurality of the steps can be combined into one step.

The description of the method is made with reference to the elevator system 1 shown in FIG. 2, which is equipped with the destination call controller technology, wherein the persons P1, P2 are located on the floor L1. At the elevator operating device 5 located there, the person P1 enters a travel request (elevator call) to the floor L4 (with or without using the credential 6) in order to be transported from the call entry floor L1 to the destination floor L4 by an elevator. Similarly, person P2 uses their mobile device 4 to enter a call; they want to be transported by an elevator from the call entry floor L1 to the destination floor Ln. A person skilled in the art will recognize that the elevator calls of persons P1, P2 can occur substantially at the same time or at different times.

In a step S2, an elevator call is received. The elevator controller 13 receives the elevator call either via the communication interface device 30 or the communication network 22.

In a step S3, an elevator A, B, C is determined that can best serve the received elevator call. The elevator controller 13 uses, for example, the allocation procedure mentioned above.

In a step S4, it is determined whether the received elevator call originates from an elevator operating device 5 (on-site call) or a mobile device 4 (remote call), i.e., the origin or source of the elevator call (call source) is determined. In one exemplary embodiment, the elevator controller 13 checks whether the elevator call is received via the communication interface device 30 or the communication network 22. If the elevator call is received, for example, via the communication interface device 30 (i.e., a remote call with the mobile device 4 as the call source), the elevator call includes a device-specific and/or person-specific identifier that uniquely identifies the mobile device 4 or the person P2, and data that directly indicate the location or from which the elevator controller 13 can determine the location. If, however, the elevator call is received via the communication network 22 (i.e., an on-site call with the elevator operating device 5 as the call source), the elevator call includes, for example, an identifier of the elevator operating device 5, from which the location (call entry floor) of the elevator operating device 5 results.

In a step S5, it is checked whether it is an on-site call. If so, the method proceeds along the YES branch to a step S6, otherwise along the NO branch back to a step S7. A person skilled in the art will recognize that in another configuration, in step S5, it can be checked whether it is a remote call; subsequent steps are then adapted accordingly.

In step S6, the elevator display device 3 is activated, which is assigned to elevator C, which handles the elevator call according to step S3. The elevator controller 13 generates a control signal for this purpose and thereby controls this elevator display device 3. The control signal includes data that cause the elevator display device 3 to visibly display an indicator. In FIG. 2, said indicator is shown as card symbol 6a; it visibly shows that elevator C is serving an on-site call.

In step S7, the elevator display device 3 is also activated, which is assigned to elevator A, which handles the elevator call according to step S3. The control signal generated for this purpose includes data that cause the elevator display device 3 to visibly display an indicator. In FIG. 2, said indicator is shown as radio symbol 4a; it visibly shows that elevator A is serving a remote call.

The display of indicators according to the steps S6 and S7 helps the persons P1, P2 to better and possibly faster recognize elevator A, C assigned to them. Especially when several elevators arrive or are ready to be boarded at substantially the same time, the risk of persons P1, P2 becoming confused and boarding the wrong elevator is reduced. Also, the boarding process can be more efficient and faster because persons P1, P2 can, for example, already position themselves in front of the respective elevator.

Further details of the elevator system 1 shown in FIG. 1 are indicated below. The communication network 22 connects the elevator operating devices 5 on the floor side to the elevator controller 8 and thus enables communication between the elevator controller 8 and the elevator operating devices 5. For this communication, the elevator operating devices 5 and the elevator controller 8 may be directly or indirectly connected to the communication network 22. The communication network 22 can include a communication bus system, individual data lines, or a combination thereof. Depending on the implementation of the communication network 22, individual addresses and/or identifiers may be allocated to the elevator controller 8 and each elevator operating device 5, such that, for example, the elevator controller 8 can send a message to a desired elevator operating device 5 in a targeted manner. Communication can take place in accordance with a protocol for wired communication, for example the Ethernet protocol. In one exemplary embodiment, the elevator operating devices 5 are supplied with electrical energy via the communication network 22.

The elevator operating device 5 can have different designs, in particular it can be configured for one or more types of credentials 6. In the building system, a credential 6 is usually assigned to a person P1, P2 or group of people (e.g., in a database for user profiles) and must be presented by person P1, P2 at the entrance to the restricted-access zone, for example for using the elevator system 1. The credential 6 can be stored as a password (code) on an information carrier (e.g., in a chip of a chip card, a magnetic stripe of a magnetic stripe card or a memory of a mobile phone) or depicted (e.g., as an optical code in the form of a QR code, a bar code or a color code, which can be depicted, for example, on card-shaped carriers or a screen of a mobile phone). In one exemplary embodiment, the credential 6 can be a biometric feature, e.g., the pattern of a fingerprint or a face pattern of person P1, P2.

The elevator operating device 5 can be adapted to the credential(s) 6 to be used in the building 2. In one exemplary embodiment, the elevator operating device 5 can include an optical reading device (e.g., a digital camera) to record, for example, an optical code from an information carrier. The information carrier can be configured, for example, in the form of a credit card-shaped employee ID card or the like; in another exemplary embodiment, a mobile phone (or a similar electronic device) of the person P1, P2, which displays the optical code on a screen, serves as the information carrier. In one exemplary embodiment, the digital camera can be used to detect a biometric credential 6. The recorded biometric credential 6 can then be used in conjunction with an identification device and biometric data stored for persons P1, P2 registered in the building 2 to determine that access is approved, e.g., by means of facial recognition.

Additionally or alternatively, the elevator operating device 5 can include a radio-based reading device which reads the credential 6 from a chip of an RFID transponder, for example. An employee ID card or the like or a mobile phone can serve as an RFID transponder, for example. In one embodiment, the radio-based reading device can be designed for communication with the mobile phone or the like according to near-field communication (NFC) or Bluetooth technology. In one exemplary embodiment, the mobile phone transmits the (electronic) credential 6 to the radio-based reading device by means of Bluetooth technology as soon as the mobile phone is within radio range of the reading device.

A person skilled in the art will recognize that the credential 6 constitutes the information that is used to check an access authorization, specifically irrespective of the type of information (code or biometric feature) and the design of any information carrier. The figures show, for example, a card-shaped information carrier on which the credential 6 is stored or displayed.

1. An elevator system, comprising:
an elevator controller communicatively connected to a communication interface device and a communication network;
an elevator car movable between respective floors under control of the elevator controller;
elevator operating devices for entering elevator calls, said elevator operating devices communicatively connected to the communication network and arranged on the respective floors;
elevator display devices communicatively connected to the communication network, said elevator display devices assigned to the elevator car and arranged on the respective floors, wherein the elevator display devices are arranged separately from the elevator operating devices and are configured to receive control signals from the elevator controller via the communication network;
wherein the elevator controller is configured to receive an elevator call originating from an elevator operating device on a call entry floor via the communication network, wherein said elevator operating device constitutes a first call source,
wherein the elevator controller is configured to receive an elevator call originating from a mobile communication device on a call entry floor via the communication interface device wherein said mobile communication device constitutes a second call source,
wherein the elevator controller is configured to generate a control signal for the elevator display device assigned to the elevator car serving the elevator call on the call entry floor and to send the control signal to said elevator display device, wherein the control signal indicates whether the elevator call originates from the first call source or the second call source, and
wherein the elevator display device is configured to, upon receipt of the control signal, communicate an indicator perceptible on the call entry floor, said indicator identifying the first call source or the second call source.

2. The elevator system according to claim 1, wherein the indicator comprises at least one of a symbol, an alphanumeric character, a pictogram, a color, an acronym and a word.

3. The elevator system according to claim 1, wherein the elevator controller comprises a destination call controller, wherein each elevator call indicates a destination floor, wherein the elevator operating devices and the mobile communication device are configured to send an entered destination floor as an elevator call to the elevator controller, wherein the control signal additionally indicates the destination floor, and wherein the elevator display device is configured to perceptibly communicate the destination floor in conjunction with the indicator.

4. The elevator system according to claim 1, wherein the elevator controller comprises a direction controller, wherein the elevator operating devices and the mobile communication device are configured to send an entered direction of travel as an elevator call to the elevator controller.

5. The elevator system according to claim 1 wherein the communication interface device is configured to receive a radio signal in accordance with a specified standard for mobile radio communication.

6. A method for operating an elevator system having an elevator controller communicatively connected to a communication interface device and a communication network, an elevator car movable between respective floors under control of the elevator controller, elevator operating devices for entering elevator calls, said elevator operating devices communicatively connected to the communication network and arranged on the respective floors and elevator display devices communicatively connected to the communication network, said elevator display devices assigned to the elevator car and arranged on the respective floors wherein the elevator display devices are arranged separately from the elevator operating devices and are configured to receive control signals from the elevator controller via the communication network, the method comprising:
receiving an elevator call by the elevator controller;
determining an elevator serving the elevator call by the elevator controller;
determining an origin of the elevator call by the elevator controller, wherein upon receipt of the elevator call via the communication network, an elevator operating device on a call entry floor constitutes a first call source, and wherein upon receipt of the elevator call via the communication interface device, a mobile communication device on a call entry floor, constitutes a second call source;
generating a control signal for the elevator display device assigned to the elevator serving the elevator call on the call entry floor, and sending the control signal to said elevator display device, wherein the control signal indicates whether the elevator call originates from the first call source or the second call source; and
activating the elevator display device to communicate, upon receipt of the control signal, an indicator perceptible on the call entry floor which identifies the first call source or the second call source.

7. The method according to claim 6, wherein the indicator comprises at least one of a symbol, an alphanumeric character, a pictogram, a color, an acronym and a word.

8. The method according to claim 6, wherein each elevator call entered on the call entry floor indicates a destination floor, wherein the control signal additionally indicates the destination floor and wherein the elevator display device perceptibly communicates the destination floor in conjunction with the indicator.

9. The method according to claim 6, wherein each elevator call entered on the call entry floor indicates a direction of travel.

10. The method according to claim 6, wherein the communication interface device is configured to receive a radio signal in accordance with a specified standard for mobile radio communication.
